(19) United States
(12) Patent Application Publication
(10) Pub. No.: US 2019/0053671 A1
(43) Pub. Date: Feb. 21, 2019

(54) CONTAINER SYSTEM AND METHOD OF USE

(71) Applicant: Ellen Trask, Easton, ME (US)

(72) Inventor: Ellen Trask, Easton, ME (US)

(21) Appl. No.: 15/679,980

(22) Filed: Aug. 17, 2017

(51) Int. Cl. A47J 47/08; A47J 47/00; B65D 1/34; B65D 43/02; B65D 61/00; B65D 85/34; B65B 7/28; B65B 63/08

(52) U.S. Cl. CPC A47J 47/08; A47J 47/005; B65D 1/34; B65D 43/0212; B65D 43/0222; B65D 2543/00537; B65D 61/00; B65D 85/34; B65B 7/28; B65B 63/08; B65D 43/0231

(57) ABSTRACT

A container system useful for holding prepared foodstuffs in a refrigerator in an organized and convenient manner, having a frame, a plurality of containers with removable lids, and a retention means for holding the containers in fixed position relative to the frame when placed therein, and a method for using same.

### CROSS REFERENCE TO RELATED APPLICATIONS

This application claims priority to and is a continuation-in-part application of the non-provisional patent application, U.S. Ser. No. 14/533,288, filed Nov. 5, 2014 and currently pending, entitled Container System, by Ellen Trask, which is hereby incorporated by reference, and further claims priority to a provisional patent application, U.S. Ser. No. 61/900,608, filed Nov. 6, 2013 and since expired, entitled The Home Salad Bar, by Ellen Trask, which is hereby incorporated by reference.

### BACKGROUND OF THE INVENTION

### 1. Technical Field

The present invention relates generally to container systems and more specifically relates to a container system for holding foodstuffs in a refrigerator for use as a home salad bar.

The present invention, though having many practical uses, is designed primarily to function as a “home salad bar”, a sleek and simple food storage unit made of a frame system with removable containers. This device may be used to store prepared vegetables and salad bar items within a refrigerator. The system of the present invention enables the user to pull out the entire unit and its containers for quick and easy preparation of a salad.

### 2. Description of Problem

Preparing healthy meals in today's busy lifestyle has always been a struggle for families. People are busy working all day, attending late day meetings and appointments, as well as attending their children's after school sports games and activities. These late days often prevent people from getting home early enough to prepare healthy meals. Lessons, games, and meetings run into suppertime, and when family members arrive home they are hungry and want to eat right away. Meals have to be prepared quickly to prevent pre-meal snacking and eating of fast food items. It is obvious that preparing healthy meals at the end of a busy work/school day is a struggle for many families. It is easier to make a quick trip through the drive through at a fast food chain than to get home and have an army of hungry children whining, “When is supper going to be ready?” When dining at a sit down restaurant family members can be placated with a trip to the salad bar while waiting for the main course. Not only does this curb their hunger, but also is a healthy way for them to fill up on the fresh vegetables they love.

Research shows us that more than one-third (34.9% or 78.6 million) of U.S. adults are obese. Approximately 17% (or 12.7 million) of U.S. children and adolescents aged 2-19 years suffer from obesity and one in three children are considered overweight. There are many reasons for the rise in obesity. They include the high cost of pre-sliced fresh fruit and vegetables, inexpensive food sources such as fast foods, increased availability of vending machines with energy-dense items, and more mothers in the workforce with less time at home to cook.

It is therefore shown that there is a need for a better way to offer fresh vegetables and fruits for consumption either on their own or as a part of a freshly made salad.

It is therefore an object of the present invention to provide a container system that can be used to prepare and store food items in a refrigerated environment for future use.

Another object of the present invention is to provide a container system that helps to reduce the time it takes for daily preparation of healthy salads.

Yet another object of the present invention is to provide a container system that reduces the amount of money spent on fresh vegetables that go to waste.

Yet another object of the present invention is to provide a container system that allows the user to prepare vegetables once a week instead of every time a salad is desired.

Yet another object of the present invention is to provide a container system that prevents vegetables from becoming cluttered and lost in the bottom of the refrigerator by allowing the user to store vegetables in an organized manner for easy access.

Yet another object of the present invention is to provide a container system that encourages children to prepare a healthy meal by themselves when parents are not home to cook.

Yet another object of the present invention is to provide a container system that allows each family member to create his or her own salad with preferred fixings to ensure that each family member is happy and content.

Yet another object of the present invention is to provide a container system that helps busy parents feed their children healthy snacks or pre-meal before the main course is served.

Yet another object of the present invention is to provide a container system that prevents snacking on high calorie and non-nutritious fast foods.

Yet another object of the present invention is to provide a container system that provides a fast way to feed a family nutritious food with little daily preparation.

Yet another object of the present invention is to provide a container system that is dishwasher safe.

Yet another object of the present invention is to provide a container system that is inexpensive to manufacture.

Yet another object of the present invention is to provide a method of using the container system.

Other objects and advantages of the present invention will become obvious to the reader and it is intended that these objects and advantages are within the scope of the present invention. To the accomplishment of the above and related objects, this invention may be embodied in the form illustrated in the accompanying drawings. Attention is called to the fact, however, that the drawings are illustrative only, and that changes may be made in the specific construction illustrated and described within the scope of this disclosure.

### SUMMARY OF THE INVENTION

The present invention is a container system comprising a frame suitably configured to retain a plurality of containers. It can be used as a convenient storage unit designed to store fresh vegetables in a refrigerator. It is different from other multi-compartment containers in that each container is independent from the other containers and the frame keeps them all together. This design allows the user to remove and insert the containers independently from each other while being able to move the entire device as one unit. Each container has a removable, sealable lid to enclose whatever items are placed therein. This is particularly important when those items are fresh food items, like lettuce, carrots, cucumbers, tomatoes, broccoli, cheese, olives, onions, and peppers. Once placed into the frame, the containers can easily be moved from place to place, for example, from the kitchen counter to the refrigerator to the dining room table. The containers may be all of the same size and shape or may be of different sizes and shapes. Each container is dishwasher safe and can be easily removed from the frame for cleaning.

The user can fill the device on Sunday evening in preparation for the week's meals. The user buys vegetables and slices them up, puts them into the individual containers, and then places the containers in the frame of the unit. The system is then placed in the refrigerator. Throughout the week, as needed, family members can remove the whole unit from the refrigerator, uncap the containers and select the items they want for their own individual salads. When done, the container lids are snapped back in place, and the whole unit is placed back in the refrigerator until another member of the family needs a quick healthy snack or meal.

The frame of the container system may be configured in any number of ways. In one class of embodiments the frame actively retains the containers, either by being configured so that the containers are friction fit into the frame, or by having engagement members which engage with corresponding members found on the containers.

In another class of embodiments the frame passively retains the containers. That is, the containers are loosely placed into the frame and hang therefrom, being retained in the frame mainly through gravity. In these embodiments an additional means of support is required. One such means of support comprises a plurality of legs which extend downward from the frame. The legs support the frame above a surface. Another means of support are rails positioned laterally on the frame, which are configured to mate with receiving members located within a refrigerator, such as the drawer runners used for cheese or meat drawers or vegetable crispers. In the preferred embodiments both the legs and the rails are used, so that the container system can be placed into a refrigerator in a dedicated, easy to use location, and then can be self-supporting when taken out of the refrigerator, all while providing easy access to the containers within the frame.

Alternate embodiments of the container system comprise a bottom tray. The bottom tray is sized substantially the same as the frame and is located below the frame, attached to the support legs. The bottom tray conveniently holds useful tools for the preparation of salads, such as a cutting board or cutlery. It also serves to retain crumbs and other stray pieces that might fall outside of the containers when they are being filled or when food is being taken out of the containers. This helps keep the work place and the refrigerator clean.

### BRIEF DESCRIPTION OF THE DRAWING

FIG. 1 depicts a perspective view of one embodiment of the present invention.

FIG. 2 depicts a perspective view of the embodiment of the present invention shown in FIG. 1, with the cutting board extracted for use in chopping foodstuffs, and with a container partially filled with foodstuffs.

FIG. 3 depicts a perspective view of another embodiment of the present invention.

FIG. 4A depicts a plan side view of one embodiment of the retention means of the present invention, both prior to placing a container into the frame and after placing the container into the frame.

FIG. 4B depicts a plan side view of another embodiment of the retention means of the present invention, both prior to placing a container into the frame and after placing the container into the frame.

FIG. 4C depicts a plan side view of yet another embodiment of the retention means of the present invention, both prior to placing a container into the frame and after placing the container into the frame.

FIG. 4D depicts a plan side view of yet another embodiment of the retention means of the present invention, both prior to placing a container into the frame and after placing the container into the frame.

FIG. 4E depicts a plan side view of yet another embodiment of the retention means of the present invention, both prior to placing a container into the frame and after placing the container into the frame.

FIG. 4F depicts a plan side view of yet another embodiment of the retention means of the present invention, both prior to placing a container into the frame and after placing the container into the frame.

FIG. 5A depicts a plan top view of one embodiment of the present invention using rails for placement of the container system into a refrigerator. Hidden elements are shown in ghost line.

FIG. 5B depicts a plan side view of the embodiment of the present invention depicted in FIG. 5A along A-A.

FIG. 6A depicts a plan top view of another embodiment of the present invention using rails for placement of the container system into a refrigerator. Hidden elements are shown in ghost line.

FIG. 6B depicts a plan side view of the embodiment of the present invention depicted in FIG. 6A along A-A.

FIG. 7 depicts a perspective view of one embodiment of the present invention being placed onto a refrigerator shelf.

### DETAILED DESCRIPTION OF THE INVENTION

The container system 1 of the present invention comprises a plurality of containers 100, a frame 200, and a retention means 300. The containers 100 are suitable for holding any item 10, but more particularly food items 10 such as one would use to make a salad. The frame 200 is appropriately configured to hold the containers 100. The retention means 300 is adapted to maintain the positional relationship of each container 100 to the frame 200.

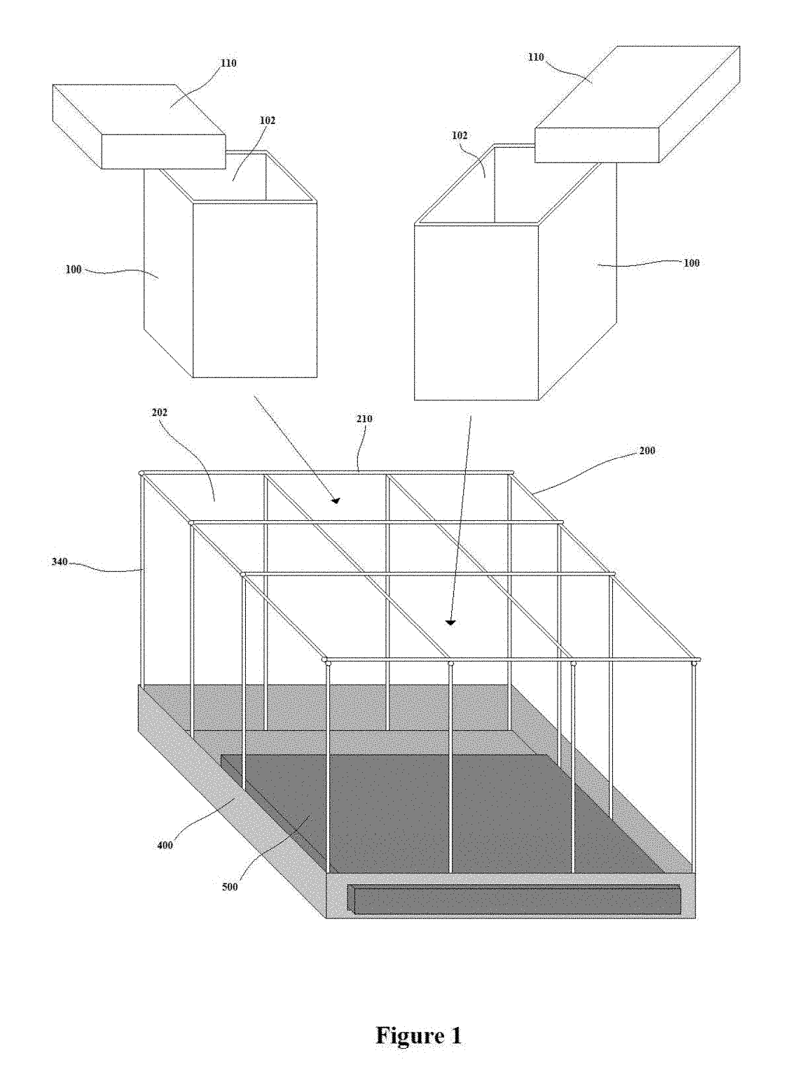

Each container 100 has an opening 102 and an interior volume. The opening 102 is oriented at the top end of the container. Each container 100 has associated with it a removable lid 110 that is capable of completely covering the opening 102 of the container. The lid 110 may be secured to the container 100 by threads, or it may simply be snapped onto the container 100 or secured by frictional forces. The containers 100 may all be of a uniform height, or they may be of different heights. The containers 100 may all be dimensioned the same, or they may be differently dimensioned. For example, some containers 100 may have a substantially square cross-section, while others may have a rectangular cross-section. See FIG. 1. Containers 100 having the same shape may be sized differently. Other shapes of the containers 100 are also contemplated, such as substantially cylindrical containers 100, see FIG. 3, containers 100 with tapered sides, containers 100 with an upper circumferential projection 310, e.g., a lip, and the like. The containers 100 and their lids 110 may be substantially transparent, or translucent, or opaque. They may be colored or colorless. They may be made of any suitable material, such as plastic or glass. In the preferred embodiments the containers 100 and their lids 110 are dishwasher safe.

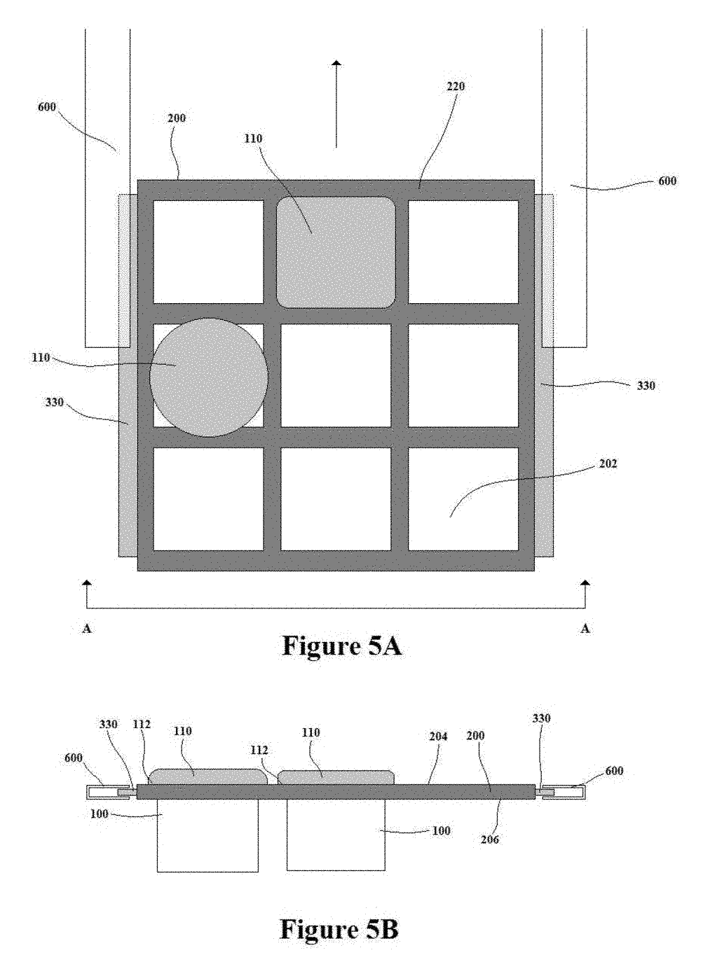

The frame 200 is a substantially rigid structure defining a plurality of apertures 202. Each aperture 202 is configured to receive within it at least one of the plurality of containers 100, such that all of the plurality of containers 100 may be placed into the apertures 202 of the frame 200, one container 100 per aperture 202. So, for example, if the container system 1 comprises nine containers 100, with three being large square shaped, two being large rectangular shaped, and four being small rectangular shaped, then the frame 200 will comprise nine apertures 202, with three of the apertures 202 being large square shaped, two being large rectangular shaped, and four being small rectangular shaped. Each of the three large square shaped containers 100 may be placed into any of the three large square shaped apertures 202, each of the two large rectangular shaped containers 100 may be placed into either of the two large rectangular shaped apertures 202, and each of the four small rectangular shaped containers 100 may be placed into any of the four small rectangular shaped apertures 202. Alternatively, the shapes of the containers 100 need not be the same as the shapes of the apertures 202, providing that the containers 100 are still able to fit into the apertures 202. For example, a cylindrical container 100 may fit into a square shaped aperture 202. See FIG. 5A.

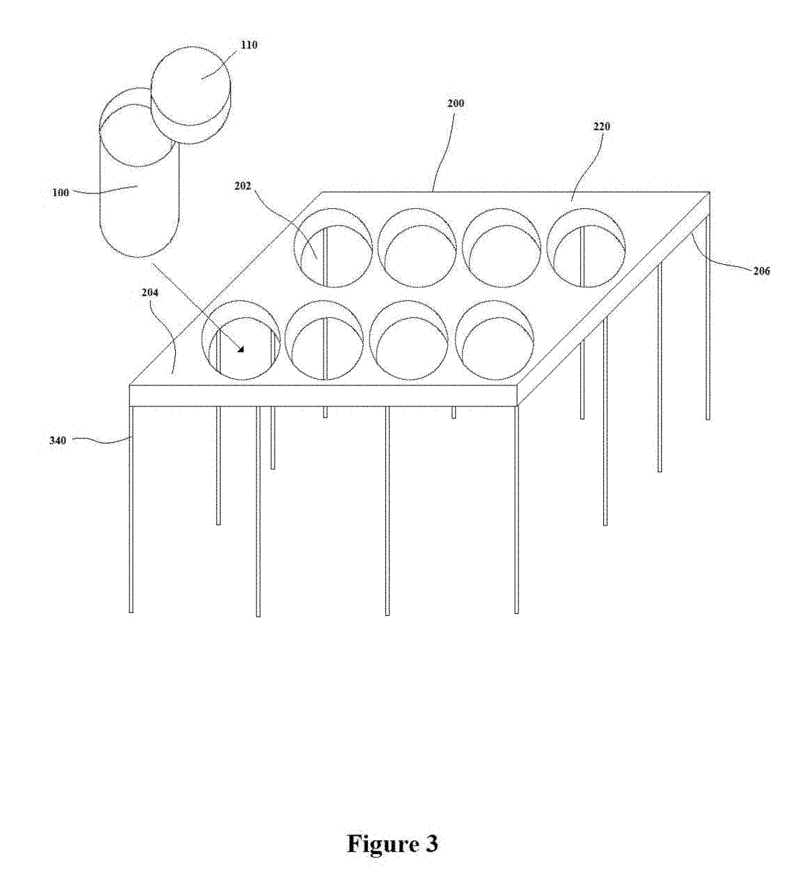

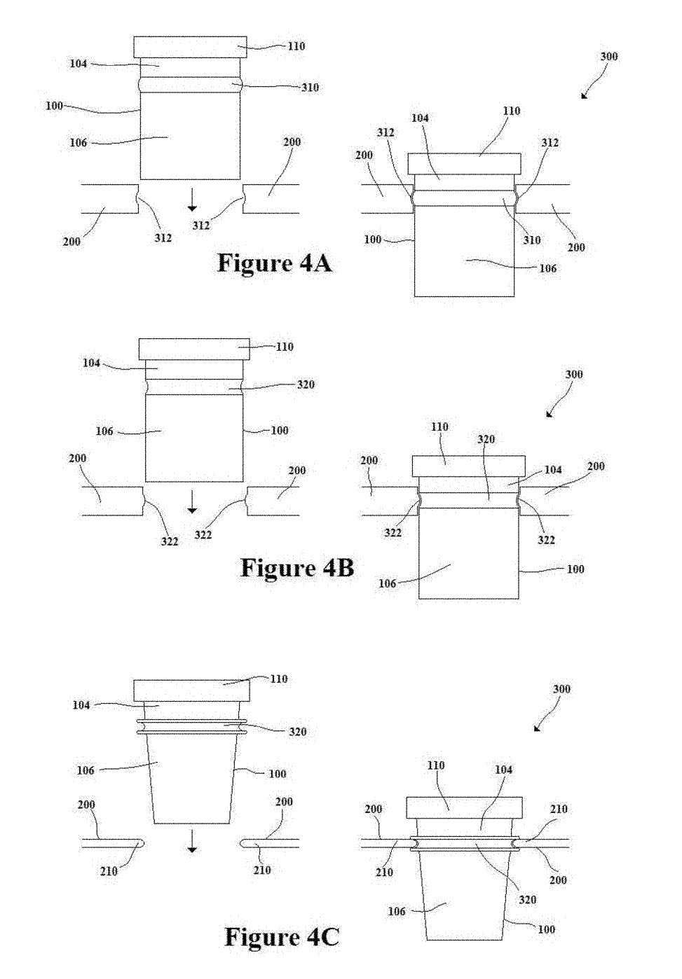

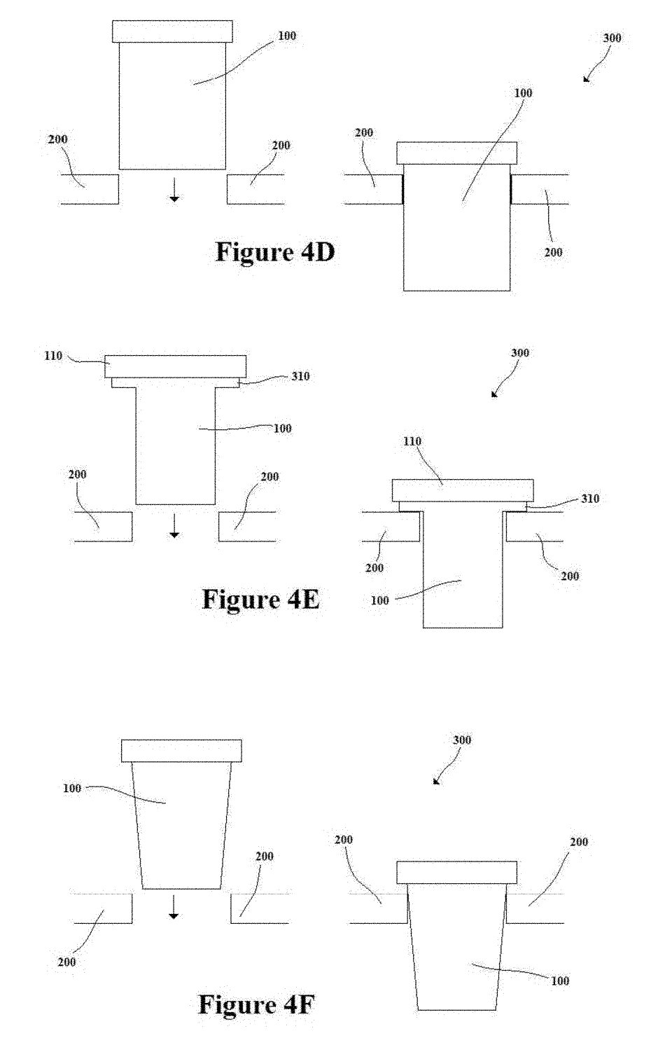

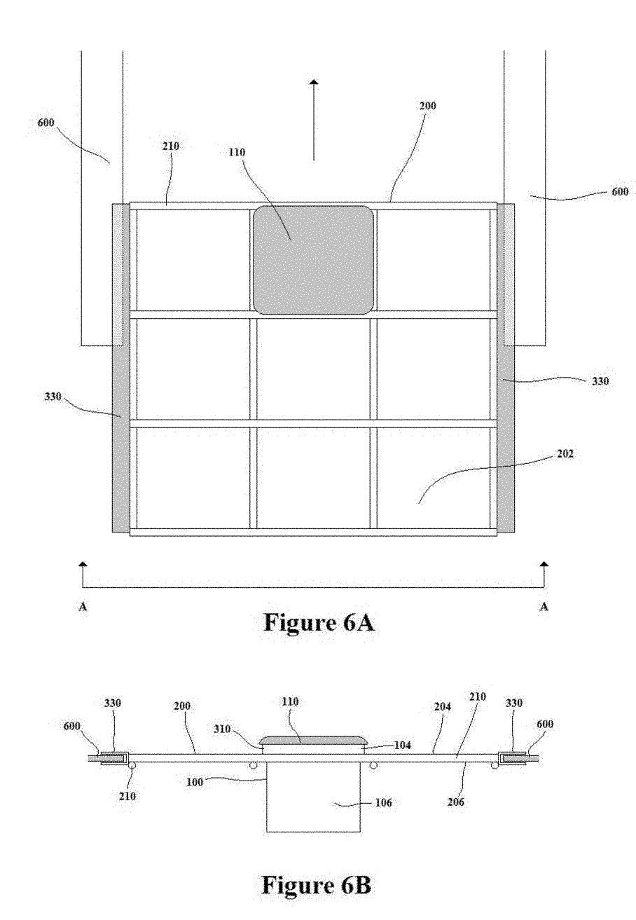

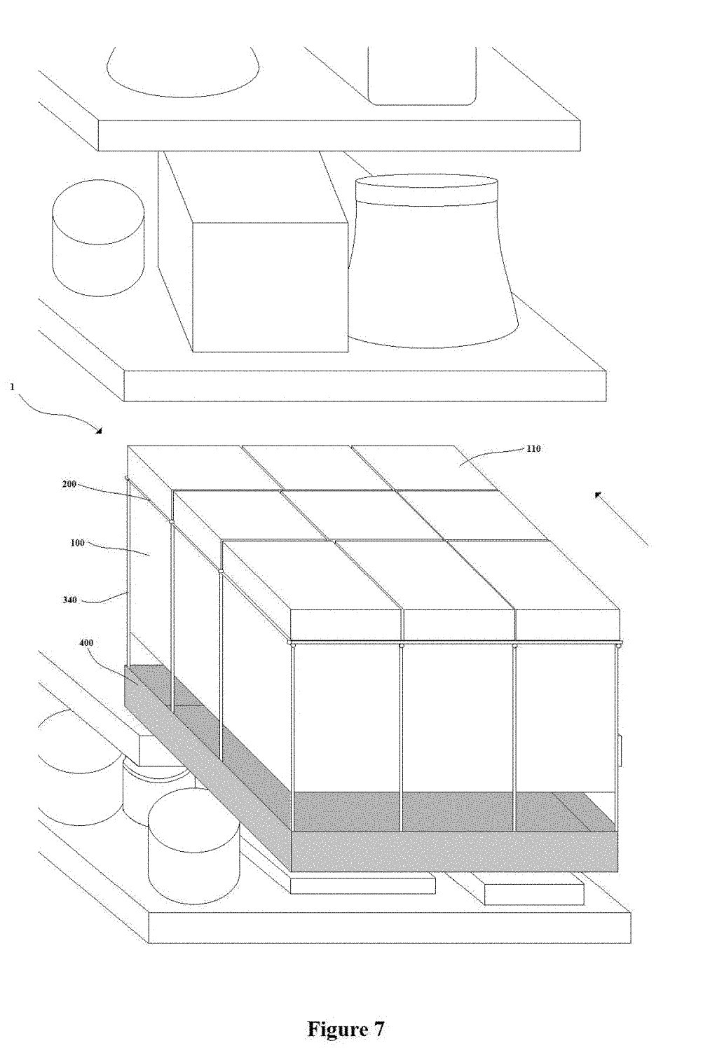

The frame 200 may be oriented substantially horizontally. It has a top surface 204 and a bottom surface 206. When a container 100 is placed into an aperture 202 of the frame 200, an upper portion 104 of the container 100 is located above the top surface 204 of the frame 200 and a lower portion 106 of the container 100 is located below the bottom surface 206 of the frame 200. See FIGS. 4A-4F and 6B.

In some embodiments the frame 200 is constructed of a substantially planar member 220, having a thickness, with the plurality of apertures 202 of the frame 200 formed into the planar member 220 through the thickness of the planar member 220. See FIGS. 3 and 5A. The planar member 220 may be made of plastic or glass or any other suitable material. In the preferred embodiments the planar member 220 is dishwasher safe.

In the preferred embodiments the frame 200 is constructed of a plurality of elongate, substantially rigid rods 210, with each of the rods 210 in connection with at least two other rods 210, thereby forming a grid. The rods 210 may be connected to each other by any appropriate means. The spaces between the rods 210 define the plurality of apertures 202 of the frame 200. See FIGS. 1, 2, and 6A. The rods 210 may be made of plastic or, preferably, of metal, such as stainless steel. In the preferred embodiments the frame 200 is dishwasher safe.

The retention means 300 of the container system 1 is any suitably adapted means that maintains the positional relationship of a container 100 to the frame 200 when the container 100 is placed into an aperture 202 of the frame 200. That is, if the frame 200 containing the containers 100 is moved from one location to another, the containers 100 remain within the frame 200 in the same positional relation to the frame 200. Thus, for example, a container 100 that has approximately 50% of its height located above the frame 200 and approximately 50% of its height located below the frame 200 (not taking into account the thickness of the frame 200) will maintain that relative positioning within the frame 200 by the retention means 300.

In one embodiment, the retention means 300 of the container system 1 requires each of the containers 100 to be appropriately dimensioned to one or more of the apertures 202 of the frame 200 so that each container 100 snugly fits into a corresponding aperture 202. See FIG. 4D. Thus, when the container 100 is placed into the aperture 202, frictional forces hold the container 100 within the aperture 202. For example, a container 100 with an outside diameter of six inches will be placed into an aperture 202 with an inside diameter of six inches. The tight fit of the container 100 within the aperture 202 results in the container 100 being maintained in fixed positional relationship to the frame 200.

In another embodiment, the retention means 300 requires that each of the containers 100 has a circumferential projection 310, and that each of the apertures 202 of the frame 200 has an interior circumferential channel 312. The circumferential projections 310 of the containers 100 are suitably configured to engage with the interior circumferential channels 312 of the apertures 202. See FIG. 4A. The engagement of the circumferential projection 310 of the container 100 with the interior circumferential channel 312 of the aperture 202 holds the container 100 within the aperture 202, resulting in the container 100 being maintained in fixed positional relationship to the frame 200. The circumferential projection 310 of the container 100 may be integrally formed into the side of the container, or it may be added after the fact (for example, a rubber gasket placed onto the container). The circumferential projection 310 of the container 100 may be continuous or discontinuous; if the latter, it may be comprised of a plurality of similar projections or projections which are dissimilar to each other or both.

In yet another embodiment, the retention means 300 requires that each of the containers 100 has a circumferential channel 320, and that each of the apertures 202 of the frame 200 has an interior circumferential projection 322. The circumferential channels 320 of the containers 100 are suitably configured to engage with the interior circumferential projections 322 of the apertures 202. See FIG. 4B. The engagement of the circumferential channel 320 of the container 100 with the interior circumferential projection 322 of the aperture 202 holds the container 100 within the aperture 202, resulting in the container 100 being maintained in fixed positional relationship to the frame 200. The circumferential projection 322 of the aperture 202 may be integrally formed into the edge of the aperture 202, or it may be added after the fact. The circumferential projection 322 of the aperture 202 may be continuous or discontinuous; if the latter, it may be comprised of a plurality of similar projections or projections which are dissimilar to each other or both.

In yet another embodiment, the retention means 300 requires that each of the containers 100 has a circumferential channel 320, as described above, to be used with a frame 200 comprised of a plurality of rods 210, as described above. The circumferential channels 320 of the containers 100 are suitably configured to engage with the rods 210 defining the apertures 202 of the frame 200. See FIG. 4C. The engagement of the circumferential channel 320 of the container 100 with the rods 210 of the frame 200 holds the container 100 within the aperture 202, resulting in the container 100 being maintained in fixed positional relationship to the frame 200.

The container system 1 may further comprise three or more support structures 340. The support structures 340 extend downward from the bottom surface 206 of the frame 200 in a substantially perpendicular orientation to the frame 200. Each of the support structures 340 has a length that exceeds the length of the bottom portion of the containers 100 such that when the container system 1 is placed onto a surface the support structures 340 maintain the containers 100 above and off the surface and maintain the frame 200 in a substantially horizontal orientation to the surface. In one variant there are four support structures 340, one located at each corner of the frame 200. In other variants there are many more support structures 340. See FIGS. 1-3 and 7. The support structures 340 may be constructed of any suitable material. Typically, the support structures 340 will be elongate metal legs.

The container system 1 may further comprise a bottom tray 400. The bottom tray 400 has a floor and sides, with an open top. The sides are substantially perpendicular to the floor, and may or may not be contiguous. The bottom tray 400 is dimensioned substantially the same as the frame 200, and the support structures 340 are placed into the bottom tray 400 and secured thereto. See FIGS. 1, 2, and 7. The bottom tray 400 provides structural rigidity to the container system 1. It may be constructed of any suitable material, such as plastic or metal. In the preferred embodiments the bottom tray 400 is dishwasher safe.

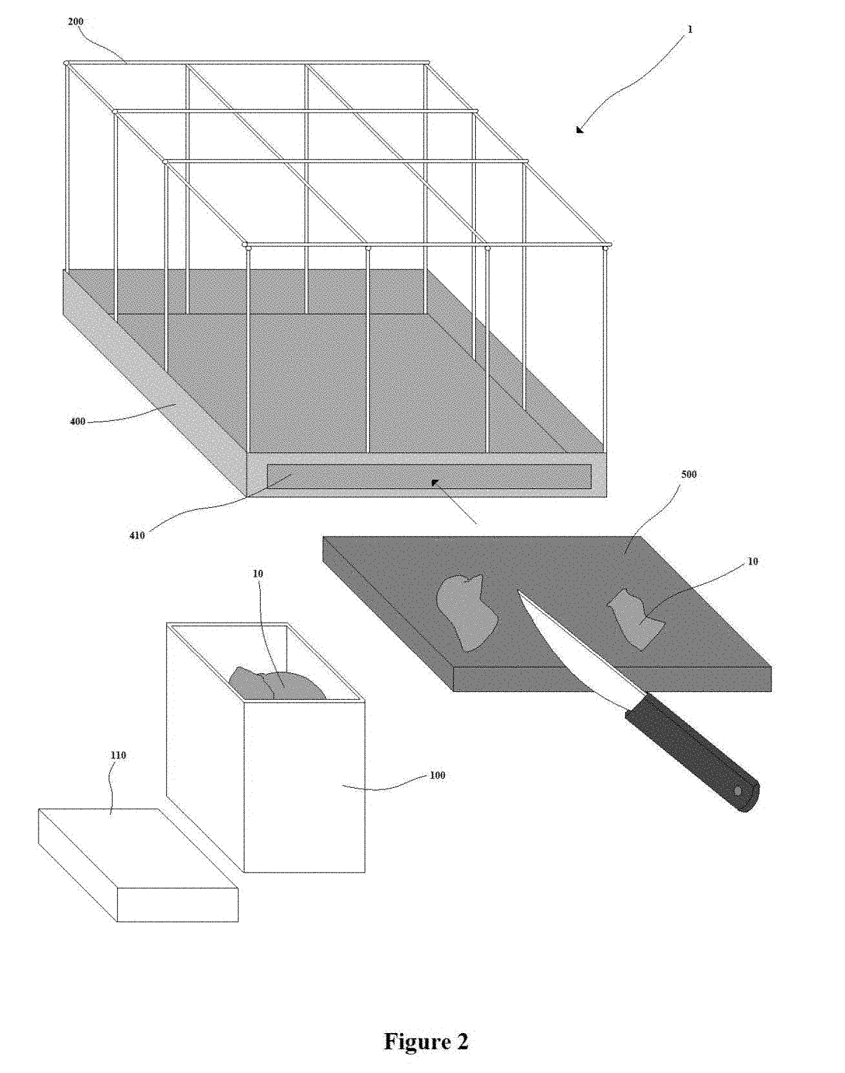

In embodiments using the bottom tray 400, the container system 1 may further comprise a cutting board 500. The cutting board 500 is suitably configured to be removably retained within the bottom tray 400. In one such embodiment, the bottom tray 400 has a slot 410 in one of its sides, and the cutting board 500 is inserted into the bottom tray 400 through the slot 410. See FIGS. 1 and 2. The cutting board 500 can be made out of plastic, or wood, or any other suitable material. In the preferred embodiments the cutting board 500 is dishwasher safe. By storing the cutting board 500 within the bottom tray 400, the user will always have it handy when preparing food items 10. See FIG. 2. Other implements can also be stored in the bottom tray 400, such as paring and chopping knives.

In yet another embodiment of the retention means 300, the retention means 300 requires that each of the containers 100 has a circumferential projection 310 located on the upper portion 104 of the container. The circumferential projection 310 may be a lip. See FIG. 4E. The circumferential projection 310 of the container 100 engages with the top surface 204 of the frame 200 when the container 100 is placed into an aperture 202 of the frame 200. See FIG. 4E. The circumferential projection 310 of the container 100 is dimensioned greater than the aperture 202 such that the circumferential projection 310 of the container 100 cannot pass through the aperture 202, resulting in the container 100 hanging from the frame 200 within the aperture 202 in fixed positional relationship to the frame 200. This configuration further results in the containers 100 being only “loosely” placed in the apertures 202 of the frame 200, allowing for easy insertion and removal. In this embodiment the container system 1 further comprises three or more support structures 340, as described above, to hold the frame 200 off a surface, since the loosely held containers 100 cannot themselves support the frame 200. This embodiment may further comprise a bottom tray 400, as described above, with or without the removable cutting board 500.

In yet another embodiment of the retention means 300, the retention means 300 requires that each of the container's associated lids 110 has an outer perimeter 112 dimensioned greater than the aperture 202 of the frame 200 into which said container 100 is placed. The outer perimeter 112 of the lid 110 engages with the top surface 204 of the frame 200 when the container 100 is placed into an aperture 202 of the frame 200. See FIGS. 5A and 5B. Because the outer perimeter 112 of the lid 110 is dimensioned greater than the aperture 202, the outer perimeter 112 of the lid 110 cannot pass through the aperture 202, resulting in the container 100 hanging from the frame 200 within the aperture 202 in fixed positional relationship to the frame 200. This configuration further results in the containers 100 being only “loosely” placed in the apertures 202 of the frame 200, allowing for easy insertion and removal. In this embodiment the container system 1 further comprises three or more support structures 340, as described above, to hold the frame 200 off a surface, since the loosely held containers 100 cannot themselves support the frame 200. This embodiment may further comprise a bottom tray 400, as described above, with or without the removable cutting board 500.

In yet another embodiment of the retention means 300, the retention means 300 requires that each of the containers 100 has a tapered side profile wherein the upper portion 104 of the container 100 is dimensioned larger than the aperture 202 of the frame 200 into which the container 100 is placed, and the lower portion 106 is dimensioned smaller than the aperture 202. See FIG. 4F. The lower portion 106 of the container 100 passes through the aperture 202 but the upper portion 104 of said container 100 does not pass through the aperture 202. The upper portion 104 of the container 100 engages with the top surface 204 of the frame 200 when the container 100 is placed into an aperture 202 of the frame 200. See FIG. 4F. This results in the container 100 hanging from the frame 200 within the aperture 202 in fixed positional relationship to the frame 200. This configuration also results in the containers 100 being only “loosely” placed in the apertures 202 of the frame 200, allowing for easy insertion and removal. In this embodiment the container system 1 further comprises three or more support structures 340, as described above, to hold the frame 200 off a surface, since the loosely held containers 100 cannot themselves support the frame 200. This embodiment may further comprise a bottom tray 400, as described above, with or without the removable cutting board 500.

In a variant of each of the foregoing “loosely held container” embodiments, the container system 1 may also comprise a pair of rails 330. The rails 330 extend laterally from the frame 200 in a substantially parallel orientation to the frame 200. Each of the rails 330 is suitably configured to be slidably engaged with receivers 600 located within a refrigerator. The rails 330 may be substantially planar, engaging with channeled receivers 600. See FIGS. 5A and 5B. Alternatively, the rails 330 may be channeled, engaging with substantially planar receivers 600. See FIGS. 6A and 6B. Other configurations of rails 330 and receivers 600 are also contemplated, such as those found in existing refrigerator vegetable drawers. When rails 330 are used, the support structures 340 may be eliminated, as the rails 330 maintain the frame 200 and containers 100 in relative location to each other. However, the support structures 340 may be used together with the rails 330, so that the container system 1 can be self supporting when removed from the refrigerator.

In the most preferred embodiment of the container system 1, configured for use as a home salad bar, the container system 1 comprises a plurality of rectangular containers 100, with each container 100 having associated with it a removable lid 110 that snaps onto the top of the container 100 and has an extended outer perimeter 112. The frame 200 is constructed of a plurality of metal rods 210, forming a grid, with the spaces between the rods 210 defining a plurality of apertures 202 into which the containers 100 may be placed. The retention means 300 comprises the outer perimeter 112 of the lids 110 of the containers 100 in engaged relation with the top surface 204 of the frame 200, together with the support structures 340. The container system 1 also comprises a bottom tray 400 secured to the support structures 340 and a removable cutting board 500 stored within the bottom tray 400. So comprised, the container system 1 is configured to be placed onto a refrigerator shelf. See FIG. 7.

Accessories for the container system 1 are also contemplated. These may include a carrying case, handles integrated into the bottom tray 400 for easier lifting, a cover for the bottom tray 400 to better protect the items placed therein, and the like.

The present invention also contemplates a method of using the container system described above. Said method includes the following steps:

Step A: obtain the container system;

Step B: place food items into one or more of the plurality of containers;

Step C: for each container into which food items were placed in Step B, place said container's associated lid onto said container, completely covering the opening of said container;

Step D: for each container into which food items were placed in Step B and onto which its associated lid was placed in Step C, place said container into one of the plurality of apertures of the frame; and

Step E: place said container system into a refrigerator.

Each of the various configurations of the container system described herein may be used in the method.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

I claim:

1. A method for using a container system for retaining and storing containers, said method comprising the following steps:
Step A: obtain said container system, wherein said container system comprises
a plurality of containers, each container having an opening and an interior volume, with each container having associated with it a removable lid that is capable of completely covering the opening of said container,
a frame, said frame defining a plurality of apertures, each said aperture being configured to receive within it at least one of the plurality of containers, such that all of the plurality of containers may be placed into the apertures of the frame, one container per aperture, and
a retention means suitably adapted to maintain the positional relationship of a container to the frame when said container is placed into an aperture of the frame, said retention means having three or more support structures, said support structures extending downward from the bottom surface of the frame in a substantially perpendicular orientation to the frame, with each of the support structures having a length such that when placed onto a surface said support structures maintain the frame in a substantially horizontal orientation to the surface;
wherein the frame is oriented substantially horizontally, having a top surface and a bottom surface, and each of the plurality of containers is oriented such that its opening is oriented upward, whereby when a container is placed into an aperture of the frame an upper portion of the container is located above the top surface of the frame and a lower portion of the container is located below the bottom surface of the frame;
Step B: place food items into one or more of the plurality of containers;
Step C: for each container into which food items were placed in Step B, place said container's associated lid onto said container, completely covering the opening of said container;
Step D: for each container into which food items were placed in Step B and onto which its associated lid was placed in Step C, place said container into one of the plurality of apertures of the frame; and
Step E: place said container system into a refrigerator.

2. The method of claim 1 wherein the container system further comprises a bottom tray, wherein the bottom tray is dimensioned substantially the same as the frame, whereby the three or more support structures are placed into the bottom tray and secured thereto.

3. The method of claim 2 wherein the container system further comprises a cutting board, wherein the cutting board is suitably configured to be removably retained within the bottom tray.

4. The method of claim 1 wherein the retention means of the container system further comprises, for each of the plurality of containers, said container's associated removable lid has an outer perimeter dimensioned greater than the aperture of the frame into which said container is placed;
wherein for each of the plurality of containers of the container system the outer perimeter of the associated removable lid of said container is suitably configured to rest on the top surface of the frame when said container is placed into an aperture of the frame, resulting in said lid preventing said container from passing completely through said aperture and said container hanging from the frame within said aperture of the frame in fixed positional relationship to the frame.

5. The method of claim 1 wherein the retention means of the container system further comprises, for each of the plurality of containers, said container has a continuously tapered profile formed from a tapered sidewall wherein the upper portion of the tapered sidewall of said container is dimensioned larger than the aperture of the frame into which said container is placed, and the lower portion of the tapered sidewall of said container is dimensioned smaller than said aperture, such that the lower portion of said tapered sidewall of said container passes through said aperture but the upper portion of said tapered sidewall of said container does not pass through said aperture;
wherein for each of the plurality of containers of the container system the upper portion of said tapered sidewall of said container engages with the top surface of the frame when said container is placed into an aperture of the frame, resulting in said container hanging from the frame within said aperture of the frame in fixed positional relationship to the frame.

6. The method of claim 1 wherein the retention means of the container system further comprises, for each of the plurality of containers, a circumferential projection located on the upper portion of the container;
wherein for each of the plurality of containers the circumferential projection of said container is suitably configured to rest on the top surface of the frame when said container is placed into an aperture of the frame, with the circumferential projection of said container being dimensioned greater than said aperture such that the circumferential projection of said container cannot pass through said aperture, resulting in said circumferential projection preventing said container from passing completely through said aperture and said container hanging from the frame within said aperture of the frame in fixed positional relationship to the frame.

7. The method of claim 1 wherein the retention means of the container system further comprises, for each of the plurality of containers, said container being appropriately dimensioned to one or more of the plurality of apertures of the frame wherein said container snugly fits into said one or more of the plurality of apertures of the frame, such that when said container is placed into said one or more of the plurality of apertures of the frame frictional forces hold said container within said aperture of the frame, whereby the container is maintained in fixed positional relationship to the frame.

8. The method of claim 1 wherein the retention means of the container system further comprises a pair of rails, said rails extending laterally from the frame in a substantially parallel orientation to the frame, with each of the rails suitably configured to be slidably engaged with receivers located within the refrigerator.

9. A container system for retaining and storing containers, wherein said container system comprises
a plurality of containers, each container having an opening and an interior volume, with each container having associated with it a removable lid that is capable of completely covering the opening of said container,
a frame, said frame defining a plurality of apertures, each said aperture being configured to receive within it at least one of the plurality of containers, such that all of the plurality of containers may be placed into the apertures of the frame, one container per aperture, and
a retention means suitably adapted to maintain the positional relationship of a container to the frame when said container is placed into an aperture of the frame, said retention means having three or more support structures, said support structures extending downward from the bottom surface of the frame in a substantially perpendicular orientation to the frame, with each of the support structures having a length such that when placed onto a surface said support structures maintain the frame in a substantially horizontal orientation to the surface;
wherein the frame is oriented substantially horizontally, having a top surface and a bottom surface, and each of the plurality of containers is oriented such that its opening is oriented upward, whereby when a container is placed into an aperture of the frame an upper portion of the container is located above the top surface of the frame and a lower portion of the container is located below the bottom surface of the frame.

10. The container system of claim 9 further comprising a bottom tray, wherein the bottom tray is dimensioned substantially the same as the frame, whereby the three or more support structures are placed into the bottom tray and secured thereto.

11. The container system of claim 10 further comprising a cutting board, wherein the cutting board is suitably configured to be removably retained within the bottom tray.

12. The container system of claim 8 wherein the retention means of the container system further comprises, for each of the plurality of containers, said container's associated removable lid has an outer perimeter dimensioned greater than the aperture of the frame into which said container is placed;
wherein for each of the plurality of containers of the container system the outer perimeter of the associated removable lid of said container is suitably configured to rest on the top surface of the frame when said container is placed into an aperture of the frame, resulting in said lid preventing said container from passing completely through said aperture and said container hanging from the frame within said aperture of the frame in fixed positional relationship to the frame.

13. The container system of claim 9 wherein the retention means of the container system further comprises, for each of the plurality of containers, said container has a continuously tapered profile formed from a tapered sidewall wherein the upper portion of the tapered sidewall of said container is dimensioned larger than the aperture of the frame into which said container is placed, and the lower portion of the tapered sidewall of said container is dimensioned smaller than said aperture, such that the lower portion of said tapered sidewall of said container passes through said aperture but the upper portion of said tapered sidewall of said container does not pass through said aperture;
wherein for each of the plurality of containers of the container system the upper portion of said tapered sidewall of said container engages with the top surface of the frame when said container is placed into an aperture of the frame, resulting in said container hanging from the frame within said aperture of the frame in fixed positional relationship to the frame.

14. The container system of claim 9 wherein the retention means of the container system further comprises, for each of the plurality of containers, a circumferential projection located on the upper portion of the container;
wherein for each of the plurality of containers the circumferential projection of said container is suitably configured to rest on the top surface of the frame when said container is placed into an aperture of the frame, with the circumferential projection of said container being dimensioned greater than said aperture such that the circumferential projection of said container cannot pass through said aperture, resulting in said circumferential projection preventing said container from passing completely through said aperture and said container hanging from the frame within said aperture of the frame in fixed positional relationship to the frame.

15. The container system of claim 9 wherein the retention means further comprises, for each of the plurality of containers, said container being appropriately dimensioned to one or more of the plurality of apertures of the frame wherein said container snugly fits into said one or more of the plurality of apertures of the frame, such that when said container is placed into said one or more of the plurality of apertures of the frame frictional forces hold said container within said aperture of the frame, whereby the container is maintained in fixed positional relationship to the frame.

16. The container system of claim 9 wherein the retention means further comprises a pair of rails, said rails extending laterally from the frame in a substantially parallel orientation to the frame, with each of the rails suitably configured to be slidably engaged with receivers located within a refrigerator.
